(19) United States
(12) Patent Application Publication
(10) Pub. No.: US 2026/0210513 A1
(43) Pub. Date: Jul. 23, 2026

(54) VEHICLE LIGHTING DEVICE

(71) Applicant: KOITO MANUFACTURING CO., LTD., Tokyo (JP)

(72) Inventor: Shoji FUJITA, Shizuoka-shi, Shizuoka (JP)

(73) Assignee: KOITO MANUFACTURING CO., LTD., Tokyo (JP)

(21) Appl. No.: 19/140,672

(22) PCT Filed: Dec. 18, 2023
(86) PCT No.: PCT/JP2023/045207

§ 371 Date: Jun. 18, 2025

(30) Foreign Application Priority Data
Dec. 27, 2022 (JP) 2022-210877

(51) Int. Cl. F21S 41/365; F21S 41/255; F21S 41/32; F21S 41/33; F21S 41/37; F21W 102/13; F21W 102/18

(52) U.S. Cl. CPC F21S 41/365; F21S 41/255; F21S 41/321; F21S 41/338; F21S 41/37; F21W 2102/13; F21W 2102/18

(57) ABSTRACT

A vehicle lighting device including a plurality of lighting device unit for forming a low-beam light distribution pattern, improvement in the forward visibility of an own-vehicle driver is achieved while the glare to an oncoming-vehicle driver is effectively restrained. In both of first and second lighting device units, outgoing lights from light sources are sequentially reflected by first additional reflectors and second additional reflectors, and thereby, as the low-beam light distribution pattern, an OHS irradiation light distribution pattern can be additionally formed in a space above cutoff lines. On that occasion, the first lighting device unit is configured such that a protrusion portion as a light diffusion region is formed at a position that is on a reflection surface of the second additional reflector and that is on an own-vehicle lane side of a back focus of a projection lens.

### TECHNICAL FIELD

The invention in the present application relates to a vehicle lighting device including a plurality of lighting device units for forming a low-beam light distribution pattern.

### BACKGROUND ART

Conventionally, a configuration of including a plurality of lighting device units is known as the configuration of a vehicle lighting device configured to form a low-beam light distribution pattern.

Moreover, a configuration of including a projection lens, a light source that is disposed on a lighting-device rearward side of a back focus of the projection lens, a reflector that reflects outgoing light from the light source toward the projection lens, and a shade that intercepts a part of reflected light from the reflector, in a state of being disposed between the reflector and the projection lens, for forming a cutoff line of the low-beam light distribution pattern is known as the configuration of each of the lighting device units.

“PTL 1” describes a configuration in which a first additional reflector that reflects the outgoing light from the light source downward is disposed on a lighting-device forward side of the reflector and a second additional reflector that reflects the outgoing light from the light source that is reflected by the first additional reflector toward the projection lens is disposed at a position on a lighting-device forward side and downward side of the back focus of the projection lens, as the configuration of the lighting device unit configured for the low-beam light distribution pattern.

### CITATION LIST

### Patent Literature

PTL 1: Japanese Unexamined Patent Application Publication No. 2019-32961

### SUMMARY OF INVENTION

### Technical Problem

In the lighting device unit described in the above “PTL 1”, the outgoing light from the light source is sequentially reflected by the first and second additional reflectors, and thereby, an OHS irradiation light distribution pattern (that is, a light distribution pattern for irradiating an over-head sign installed above a vehicle forward road surface) can be formed in a space above cutoff lines of the low-beam light distribution pattern.

However, in the vehicle lighting device including the lighting device units, in the case where this configuration is employed for each of the lighting device units, there is a fear that a space between the cutoff lines and the OHS irradiation light distribution pattern may also become brighter than necessary, which may cause glare to an oncoming-vehicle driver.

In response, when a protrusion portion or the like is formed at a position that is on a reflection surface of the second additional reflector and that is on an own-vehicle lane side of the optical axis of the projection lens as the configuration of each of the lighting device units, it is possible to locally reduce the brightness of an upward space near an oncoming-lane-side cutoff line of the low-beam light distribution pattern.

Moreover, by employing this configuration, it is possible to avoid the glare from being caused to the oncoming-vehicle driver. However, there is a fear that the space between the cutoff lines and the OHS irradiation light distribution pattern may become excessively dark and the forward visibility of an own-vehicle driver may decrease.

The invention in the present application has been made in view of the circumstances, and an object is to provide a vehicle lighting device that includes a plurality of lighting device units for forming the low-beam light distribution pattern and that can achieve the improvement in the forward visibility of the own-vehicle driver while effectively restraining the glare to the oncoming-vehicle driver.

### Solution to Problem

The invention in the present application achieves the above object by devising the configuration of the second additional reflector in each of the lighting device units.

That is, a vehicle lighting device according to the invention in the present application is
a vehicle lighting device including a plurality of lighting device units for forming a low-beam light distribution pattern, characterized in that:
   each of the lighting device units includes a projection lens, a light source that is disposed on a lighting-device rearward side of a back focus of the projection lens, a reflector that reflects outgoing light from the light source toward the projection lens, and a shade that intercepts a part of reflected light from the reflector, in a state of being disposed between the reflector and the projection lens, for forming a cutoff line of the low-beam light distribution pattern;
   each of the lighting device units is configured such that a first additional reflector is disposed at a front end portion of the reflector and a second additional reflector is disposed at a position on a lighting-device forward side and downward side of the back focus, the first additional reflector reflecting the outgoing light from the light source downward, the second additional reflector reflecting the outgoing light from the light source that is reflected by the first additional reflector, toward the projection lens; and
   at least one of the lighting device units among the lighting device units is configured such that a light diffusion region is provided at a position that is on a reflection surface of the second additional reflector and that is on an own-vehicle lane side of the back focus.

Among the above “plurality of lighting device units”, the specific number of lighting device units having a configuration in which the light diffusion region is formed on the reflection surface of the second additional reflector is not particularly limited.

The above “light diffusion region” means a region having a surface shape on which the reflected light from the first additional reflector is diffused compared to a general region (that is, a region other than the light diffusion region) on the reflection surface of the second additional reflector. The specific surface shape is not particularly limited, and for example, a surface shape configured as a protrusion portion or a recessed portion, a surface shape to which frost processing, emboss processing or the like is performed, a surface shape configured as a region where surface processing such as aluminum deposition is not partially performed, and the like can be employed.

### Advantageous Effects of Invention

The vehicle lighting device according to the invention in the present application includes the projection lens, the light source that is disposed on the lighting-device rearward side of the back focus, the reflector that reflects the outgoing light from the light source toward the projection lens, and the shade that intercepts a part of the reflected light from the reflector in the state of being disposed between the reflector and the projection lens, for forming the cutoff line of the low-beam light distribution pattern, as the configuration of each of the lighting device units for forming the low-beam light distribution pattern. The first additional reflector that reflects the outgoing light from the light source downward is disposed at the front end portion of the reflector, and the second additional reflector that reflects the outgoing light from the light source that is reflected by the first additional reflector, toward the projection lens is disposed at the position on the lighting-device forward side and downward side of the back focus of the projection lens. Therefore, the following function effects can be obtained.

That is, the outgoing light from the light source is sequentially reflected by the first and second additional reflectors, and thereby, as the low-beam light distribution pattern, an OHS irradiation light distribution pattern can be additionally formed in a space above the cutoff lines.

Furthermore, at least one of the lighting device units among the lighting device units is configured such that the light diffusion region is formed at the position that is on the reflection surface of the second additional reflector and that is on the own-vehicle lane side of the back focus of the projection lens. Therefore, it is possible to avoid a space between the cutoff lines and the OHS irradiation light distribution pattern from becoming brighter than necessary, and thereby, it is possible to effectively restrain glare from being caused to an outgoing-vehicle driver.

On that occasion, the light diffusion region is formed on the reflection surface of the second additional reflector, in at least one of the lighting device units among the lighting device units. Therefore, it is possible to avoid the space between the cutoff lines and the OHS irradiation light distribution pattern from becoming excessively dark, and thereby, it is possible to avoid the forward visibility of an own-vehicle driver from decreasing.

In this way, with the invention in the present application, in the vehicle lighting device including the lighting device units for forming the low-beam light distribution pattern, it is possible to achieve the improvement in the forward visibility of the own-vehicle driver while effectively restraining the glare to the oncoming-vehicle driver.

In the above configuration, further, when the light diffusion region is constituted by a protrusion portion or a recessed portion, it is possible to accurately perform a reflection control for avoiding the space between the cutoff lines and the OHS irradiation light distribution pattern from becoming brighter than necessary.

In the above configuration, further, when the reflector is configured to be disposed so as to cover the light source from an upward side and the shade is configured to include an upward reflection surface that reflects a part of the reflected light from the reflector upward toward the projection lens as the configuration of each of the lighting device units, it is possible to efficiently emit the outgoing light from the light source toward the lighting-device forward side, and thereby, it is possible to increase the brightness of the low-beam light distribution pattern.

In the above configuration, further, when the first additional reflector is configured to be provided integrally with the reflector and the second additional reflector is configured to be provided integrally with the shade, it is possible to achieve reduction in the number of components of the vehicle lighting device, and it is possible to enhance position relation accuracy between the first additional reflector and the reflector and position relation accuracy between the second additional reflector and the shade.

On that occasion, when the lighting device units are configured such that the reflectors are integrally provided and the shades are integrally provided, it is possible to achieve further reduction in the number of components of the vehicle lighting device.

### BRIEF DESCRIPTION OF DRAWINGS

FIG. 1 is a front view showing a vehicle lighting device according to an embodiment of the invention in the present application.

FIG. 2 is a plan view showing a lighting device unit assembly of the vehicle lighting device.

FIG. 3 is a III-III line sectional view of FIG. 2.

FIG. 4 is an IV-IV line sectional view of FIG. 2.

FIG. 5 is a perspective view showing the lighting device unit assembly.

FIG. 6 is a VI portion detail view of FIG. 5.

FIG. 7 is a diagram showing a low-beam light distribution pattern that is formed by irradiation light from the vehicle lighting device.

FIG. 8 is a diagram showing first and second light distribution patterns that constitute the low-beam light distribution pattern.

FIG. 9 is a diagram showing a first modification of the embodiment in the same manner as FIG. 6.

FIG. 10 is a diagram showing a second modification of the embodiment in the same manner as FIG. 6.

### DESCRIPTION OF EMBODIMENTS

Embodiments of the invention in the present application will be described below with use of the drawings.

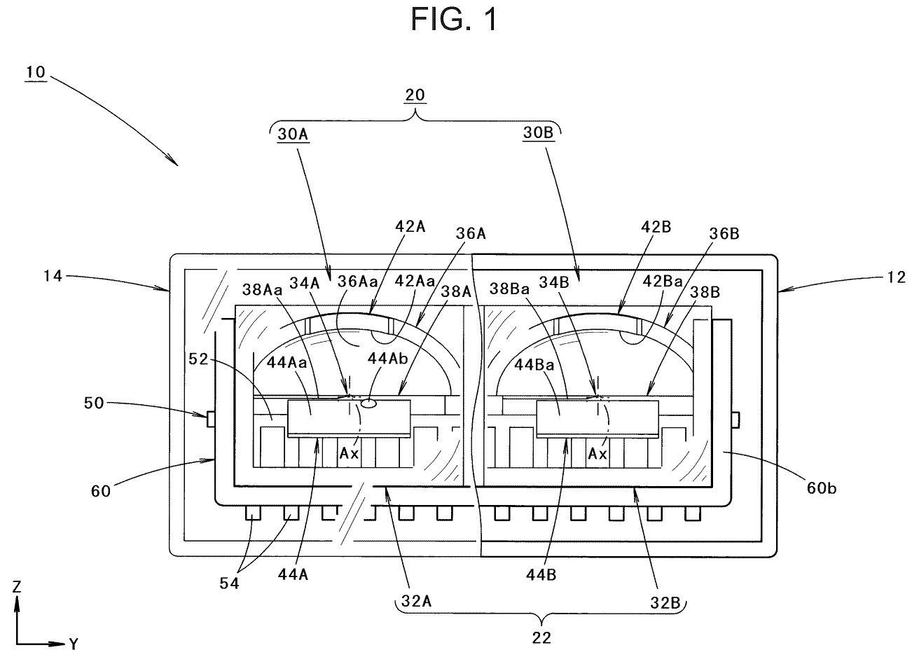

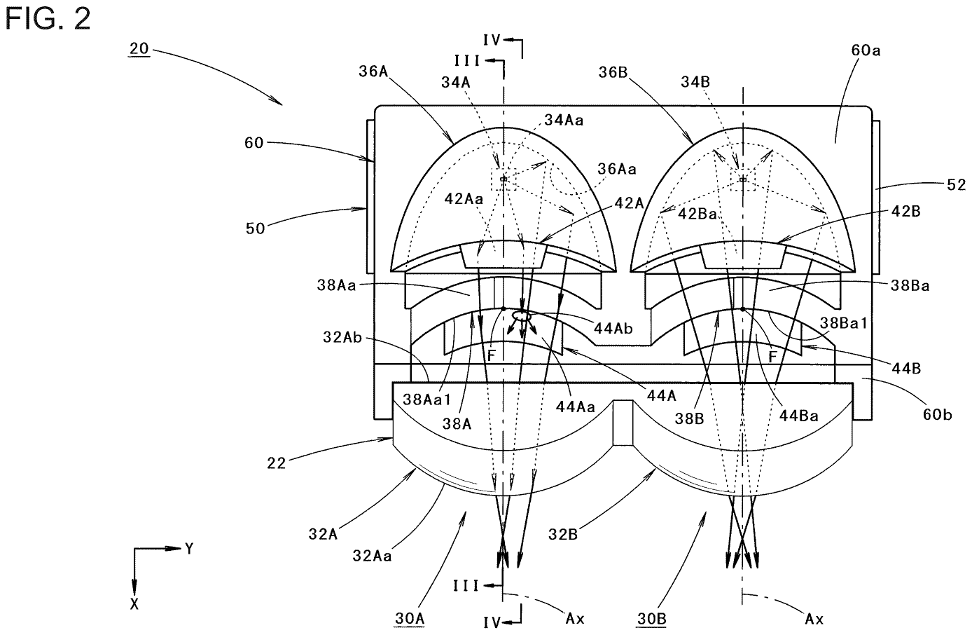

FIG. 1 is a front view showing a vehicle lighting device 10 according to an embodiment of the invention in the present application. Further, FIG. 2 is a plan view showing a lighting device unit assembly 20 of the vehicle lighting device 10.

In FIGS. 1 and 2, the direction indicated by X is a “lighting-device forward direction”, the direction indicated by Y is a “leftward direction” (a “rightward direction” in lighting-device front view) orthogonal to the “lighting-device forward direction”, and the direction indicated by Z is an “upward direction”. The same goes for the figures other than FIGS. 1 and 2.

As shown in FIGS. 1 and 2, the vehicle lighting device 10 according to the embodiment is a head lamp that is disposed at a front end portion of a vehicle, and is configured such that the lighting device unit assembly 20 is housed in a lighting chamber formed by a lamp body 12 and a plain translucent cover 14 attached to a front-end opening portion thereof.

The lighting device unit assembly 20 is configured such that first and second lighting device units 30A, 30B for forming a low-beam light distribution pattern are integrally formed.

The first and second lighting device units 30A, 30B are each configured as a projector-type lighting device unit, and are disposed so as to be arrayed in a right-left direction (that is, a vehicle-width direction). Specifically, the first lighting device unit 30A is positioned on the right side, and the second lighting device unit 30B is positioned on the left side.

The first lighting device unit 30A includes a projection lens 32A having an optical axis Ax that extends in a lighting-device front-rear direction, a light source 34A disposed on a lighting-device rearward side of a back focus (to be precise, a back focus in a vertical section) F of the projection lens 32A, a reflector 36A that reflects outgoing light from the light source 34A, toward the projection lens 32A, in a state of being disposed so as to cover the light source 34A from an upward side, and a shade 38A that intercepts a part of reflected light from the reflector 36A, in a state of being disposed between the reflector 36A and the projection lens 32A.

The second lighting device unit 30B also is configured to include a projection lens 32B, a light source 34B, a reflector 36B, and a shade 38B, similarly to the first lighting device unit 30A.

Next, the specific configuration of each of the first and second lighting device units 30A, 30B will be described.

First, the specific configuration of the first lighting device unit 30A will be described.

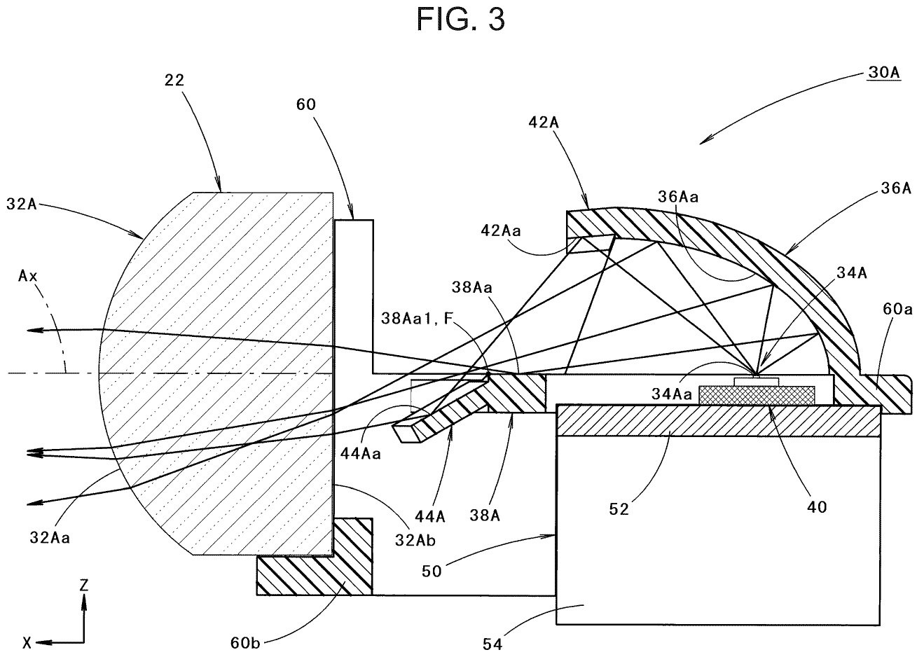

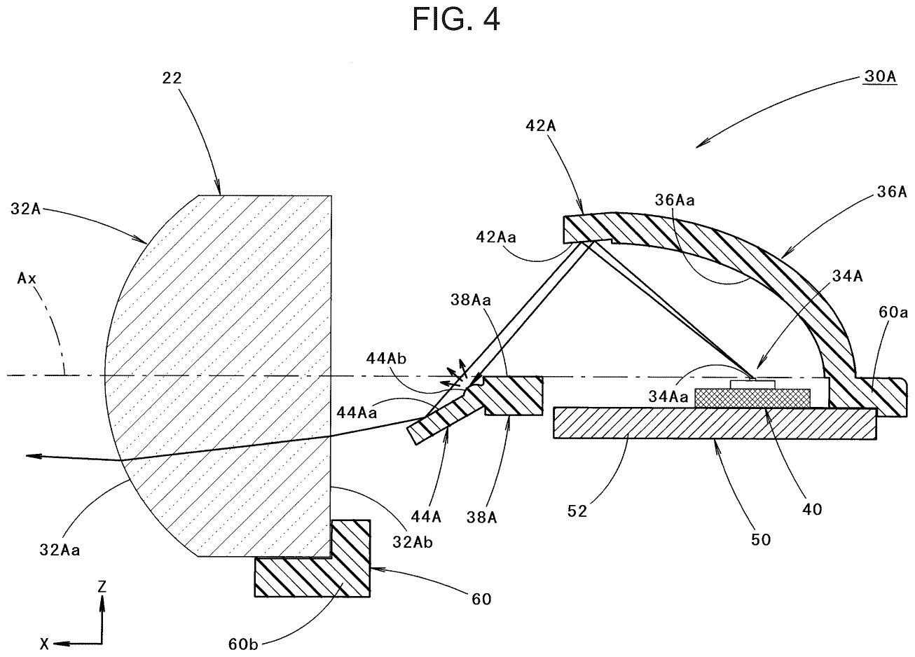

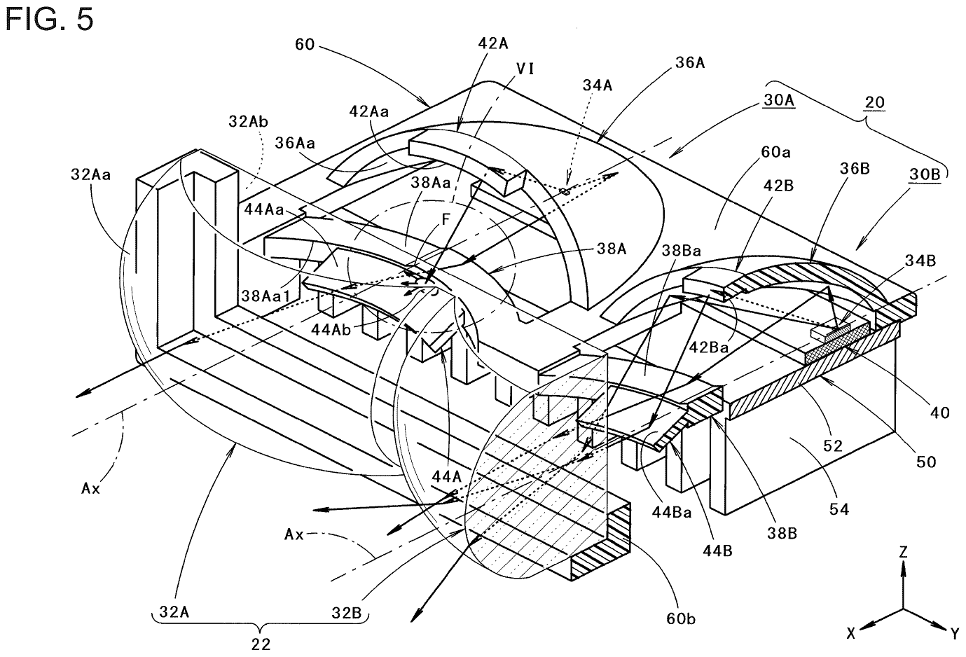

FIG. 3 is a III-III line sectional view of FIG. 2, and FIG. 4 is an IV-IV line sectional view of FIG. 2. Further, FIG. 5 is a perspective view showing the lighting device unit assembly 20.

As shown in FIGS. 3 to 5, the projection lens 32A is a plane-convex aspheric lens in which a front surface 32Aa is a convex curved surface and a rear surface 32Ab is a flat surface, and projects a light source image formed on a back focus plane that is a focal plane including the back focus F, on a virtual vertical screen on a lighting-device forward side, as a reverse image. The projection lens 32A has an outer shape that is a horizontally-long rectangular shape in lighting-device front view.

The light source 34A is a light-emitting element (specifically, a white light-emitting diode), and includes a light-emitting surface 34Aa having a horizontally-long rectangular shape. Moreover, the light source 34A is supported by a basal plate 40 in a state where the light-emitting surface 34Aa is oriented upward on the optical axis Ax.

The reflector 36A is configured to cause the outgoing light from the light source 34A to enter the projection lens 32A as light that converges with respect to the right-left direction.

Specifically, a reflection surface 36Aa of the reflector 36A is configured as a curved surface that has a roughly elliptical surface shape and that adopts a light emission center of the light source 34A as a first focal point, and the eccentricity is set so as to gradually increase from a vertical section to a horizontal section. Moreover, thereby, the reflector 36A converges the outgoing light from the light source 34A on a point positioned on the lighting-device forward side of the back focus F, in the vertical section, and displaces the convergence position further to the lighting-device forward side, in the horizontal section.

On the shade 38A, an upward reflection surface 38Aa that reflects a part of the reflected light from the reflector 36A upward toward the projection lens 32A is formed. On the upward reflection surface 38Aa, a left-side region positioned on the left side (the right side in lighting-device front view) of the optical axis Ax is configured by a horizontal surface including the optical axis Ax, and a right-side region positioned on the right side of the optical axis Ax is configured by a horizontal surface that is lowered by a step from the left-side region through a short oblique surface. Further, on the upward reflection surface 38Aa, a front end edge 38Aa1 is formed so as to extend from the back focus F of the projection lens 32A toward both right and left sides while being curved to the lighting-device forward side, and a rear end edge also is formed so as to extend toward both right and left sides while being curved to the lighting-device forward side.

A first additional reflector 42A is disposed at a front end portion of the reflector 36A. The first additional reflector 42A includes a reflection surface 42Aa formed so as to extend from a front end edge of the reflection surface 36Aa of the reflector 36A toward the lighting-device forward side while being inclined slightly downward. Moreover, the first additional reflector 42A is configured to reflect, on the reflection surface 42Aa, the outgoing light of the light source 34A, downward toward a space on the lighting-device forward side of the front end edge 38Aa1 of the upward reflection surface 38Aa of the shade 38A. The first additional reflector 42A is formed integrally with the reflector 36A.

The first additional reflector 42A is formed such that a front end edge of the reflection surface 42Aa is positioned on the lighting-device rearward side of the rear end edge of the upward reflection surface 38Aa of the shade 38A, and thereby, is configured such that the shade 38A and the reflector 36A do not overlap in planar view.

A second additional reflector 44A is disposed at a position on the lighting-device forward side and downward side of the upward reflection surface 38Aa of the shade 38A. The second additional reflector 44A includes a reflection surface 44Aa formed so as to extend from a downward position near the front end edge 38Aa1 of the upward reflection surface 38Aa of the shade 38A to the lighting-device forward side while being inclined slightly downward. Moreover, the second additional reflector 44A is configured to reflect, on the reflection surface 44Aa, the outgoing light from the light source 34A that is reflected by the first additional reflector 42A, toward the projection lens 32A. The second additional reflector 44A is formed integrally with the shade 38A.

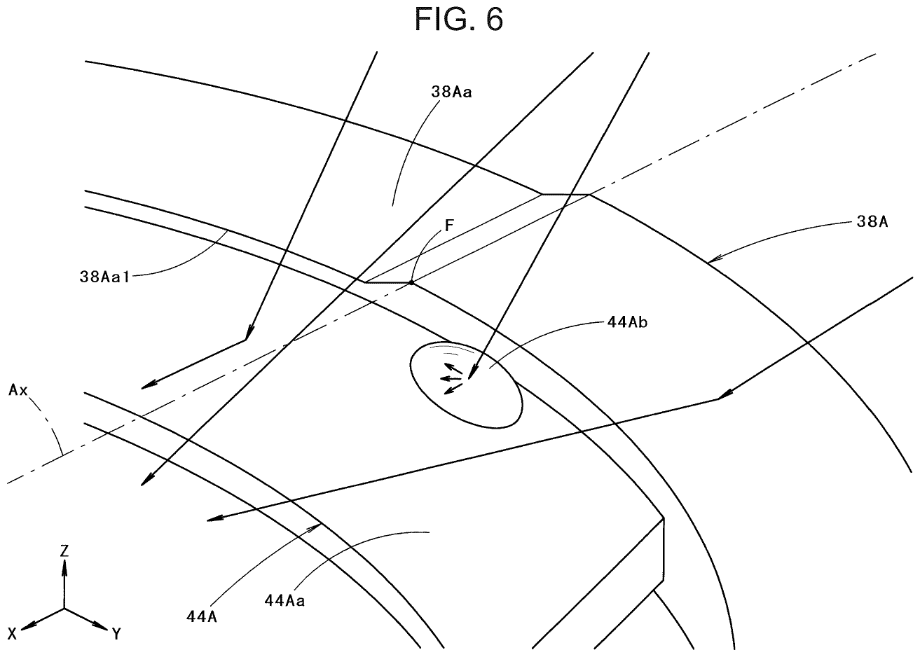

FIG. 6 is a VI portion detail view of FIG. 5.

As shown in FIG. 6, on the reflection surface 44Aa of the second additional reflector 44A, a protrusion portion 44Ab as a light diffusion region is formed at a position on the left side of the optical axis Ax (that is, a position on an own-vehicle lane side of the back focus F of the projection lens 32A). The protrusion portion 44Ab is positioned near an upper end edge of the reflection surface 44Aa, and has a surface shape that is a horizontally-long roughly-elliptical surface shape. Moreover, the protrusion portion 44Ab is configured to diffuse and reflect a part of the outgoing light from the light source 34A that is reflected by the first additional reflector 42A.

Next, the specific configuration of the second lighting device unit 30B will be described.

As described above, in the second lighting device unit 30B, the configurations of the projection lens 32B, the light source 34B, the reflector 36B, and the shade 38B are the same as those in the case of the first lighting device unit 30A, and the basic configurations of the first and second additional reflectors 42B, 44B also are the same as those in the case of the first lighting device unit 30A. However, the configuration of the second additional reflector 44B is partially different from that in the case of the first lighting device unit 30A.

That is, also in the second lighting device unit 30B, a first additional reflector 42B is disposed at a front end portion of the reflector 36B, and a second additional reflector 44B is disposed at a position on the lighting-device forward side and downward side of an upward reflection surface 38Ba of the shade 38B. Moreover, the outgoing light from the light source 34B is sequentially reflected by reflection surfaces 42Ba, 44Ba of the first and second additional reflectors 42B, 44B, and is caused to enter the projection lens 32B.

However, a protrusion portion such as the protrusion portion 44Ab formed on the reflection surface 44Aa of the second additional reflector 44A of the first lighting device unit 30A is not formed on the reflection surface 44Ba of the second additional reflector 44B of the second lighting device unit 30B.

The lighting device unit assembly 20 is configured such that the light sources 34A, 34B of the first and second lighting device units 30A, 30B are supported by a heatsink 50 made of metal through a common basal plate 40, and the heatsink 50 is supported by a holder 60 made of resin.

The holder 60 includes a horizontal flange portion 60a that extends along a horizontal plane so as to surround outer circumference portions of the reflectors 36A, 36B of the first and second lighting device units 30A, 30B. Moreover, the two reflectors 36A, 36B are formed integrally with the holder 60.

The heatsink 50 includes a body portion 52 that extends in the right-left direction along a horizontal plane, and a plurality of radiation fins 54 that is formed so as to extend downward from a lower surface of the body portion 52, and the radiation fins 54 are disposed at intervals in the right-left direction. Moreover, the heatsink 50 is supported by the holder 60, in a state where the body portion 52 abuts on the horizontal flange portion 60a of the holder 60 from a downward side.

The shades 38A, 38B of the first and second lighting device units 30A, 30B also are formed integrally with the holder 60.

The projection lenses 32A, 32B of the first and second lighting device units 30A, 30B are supported by the holder 60, in a state of being integrally formed as a projection lens assembly 22.

That is, a frame portion 60b that extends along a vertical plane orthogonal to the lighting-device front-rear direction is formed at a front end portion of the holder 60. The frame portion 60b is formed in a horizontally-long U-shape in lighting-device front view, and has an L-shaped section shape. Moreover, the projection lens assembly 22 is supported by the holder 60, in a state where circumference portions of the rear surfaces of the two projection lenses 32A, 32B abut on the frame portion 60b of the holder 60 from the lighting-device forward side.

In this way, in the lighting device unit assembly 20, the reflectors 36A, 36B, shades 38A, 38B, and first and second additional reflectors 42B, 44B of the first and second lighting device units 30A, 30B and the holder 60 are integrally formed, and thereby, the vehicle lighting device 10 is configured such that optical axis adjustments for the first and second lighting device units 30A, 30B are integrally performed.

In the lighting device unit assembly 20, no portion overlapping in planar view exists on the reflectors 36A, 36B, the shades 38A, 38B, the first and second additional reflectors 42B, 44B, and the holder 60, and therefore, when they are molded as a single injection-molded article, a mold that is used therefor has a simple structure.

In a state of being built in the vehicle lighting device 10, the lighting device unit assembly 20 is disposed in a state where the optical axes Ax of the first and second lighting device units 30A, 30B extend toward the lighting-device forward side in a downward direction of about 0.5° to 0.6° with respect to a horizontal plane.

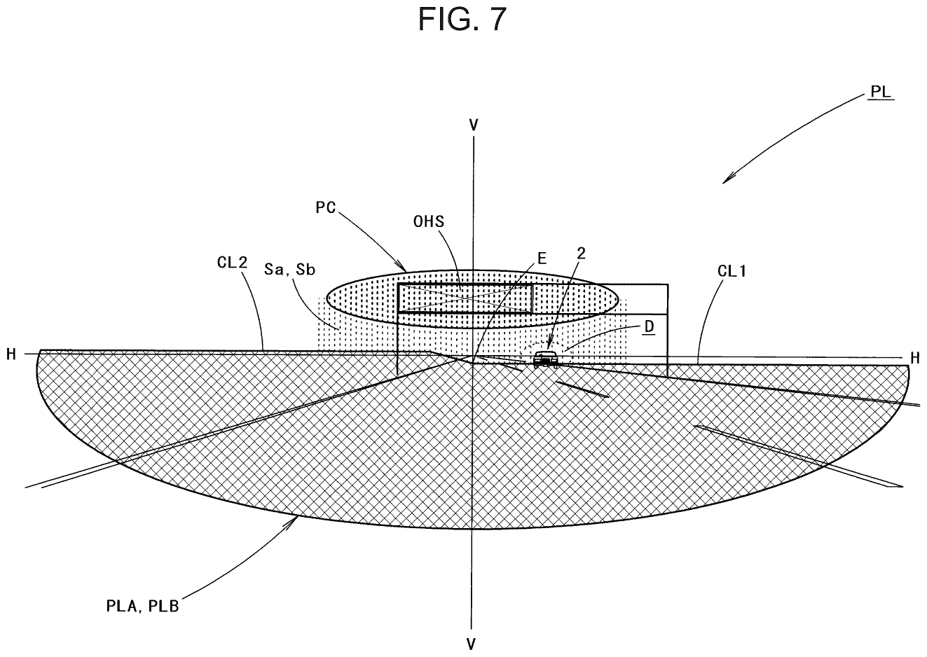

FIG. 7 is a diagram showing a low-beam light distribution pattern PL that is formed by irradiation light from the vehicle lighting device 10, in a perspective manner.

As shown in FIG. 7, the low-beam light distribution pattern PL is a low-beam light distribution pattern for left light distribution, and has cutoff lines CL1 CL2 having different right-left levels, at an upper end edge. The cutoff lines CL1, CL2 extend in the horizontal direction so as to have different right-left levels from a V-V line that vertically passes through H-V that is a vanishing point in a lighting-device front direction. A portion on the right side of the V-V line is formed as an oncoming-lane-side cutoff line CL1, and a portion on the left side of the V-V line is formed as an own-vehicle-lane-side cutoff line CL2 that is next to an inclined portion so as to have a higher level than the oncoming-lane-side cutoff line CL1.

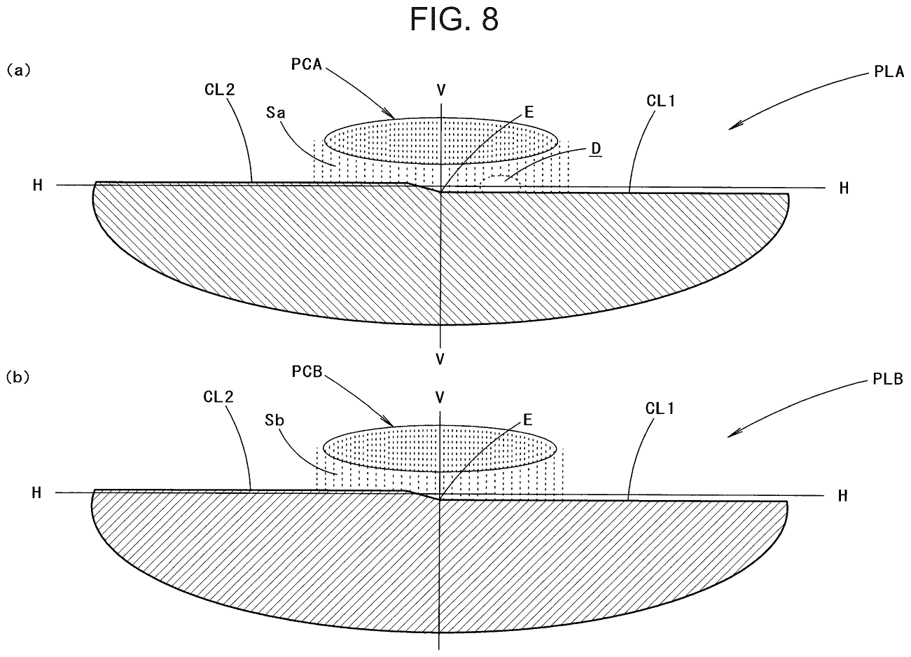

The low-beam light distribution pattern PL is formed as a synthetic light distribution pattern of a first light distribution pattern PLA shown in FIG. 8(a) and a second light distribution pattern PLB shown in FIG. 8(b). On that occasion, the first light distribution pattern PLA is a light distribution pattern that is formed by the irradiation light from the first lighting device unit 30A, and the second light distribution pattern PLB is a light distribution pattern that is formed by the irradiation light from the second lighting device unit 30B.

In the low-beam light distribution pattern PL, an elbow point E that is the intersection point between the oncoming-lane-side cutoff line CL1 and the V-V line is positioned at about 0.5° to 0.6° below the H-V. This is because the optical axes Ax of the first and second lighting device units 30A, 30B extend toward the lighting-device forward side in a downward direction of about 0.5° to 0.6° with respect to the horizontal plane.

An OHS irradiation light distribution pattern PC is additionally formed in a space above the cutoff lines CL1, CL2 of the low-beam light distribution pattern PL. The OHS irradiation light distribution pattern PC is a light distribution pattern for irradiating an over-head sign OHS installed above a vehicle forward road surface, and is formed as a horizontally-long light distribution pattern that spreads in the right-left direction from the V-V line at a position that is away upward from the cutoff lines CL1, CL2.

The first light distribution pattern PLA shown in FIG. 8(a) is formed by projecting a light source image of the light source 34A formed on a back focus plane of the projection lens 32A by the outgoing light from the light source 34A that is reflected by the reflector 36A, on the above virtual vertical screen as a reverse projection image by the projection lens 32A, and the cutoff lines CL1, CL2 are formed as a reverse projection image of a front end edge 38A1 of the upward reflection surface 38Aa of the shade 38A.

An OHS irradiation light distribution pattern PCA is additionally formed in the first light distribution pattern PLA. The OHS irradiation light distribution pattern PCA is formed by reflecting the outgoing light from the light source 34A that is reflected downward by the first additional reflector 42A, toward the lighting-device forward side by the second additional reflector 44A, and thereafter irradiating the lighting-device forward side through the projection lens 32A. On that occasion, by the reflected light from the second additional reflector 44A, also in a space between the OHS irradiation light distribution pattern PCA and the cutoff lines CL1, CL2, a diffusion light-distribution pattern Sa is formed with a weaker brightness than the OHS irradiation light distribution pattern PCA.

However, in the diffusion light-distribution pattern Sa, an upward region near the oncoming-lane-side cutoff line CL1 is locally formed as a dark portion D. The dark portion D is formed by diffusing and reflecting a part of the reflected light from the first additional reflector 42A at the protrusion portion 44Ab formed at a region that is on the reflection surface 44Aa of the second additional reflector 44A and that is on the own-vehicle lane side.

On that occasion, the formation position of the protrusion portion 44Ab on the reflection surface 44Aa of the second additional reflector 44A is set to such a position that the dark portion D roughly coincides with the position of an oncoming vehicle 2 shown in FIG. 7 when the oncoming vehicle 2 comes close to about 50 m before the own-vehicle.

On the other hand, the second light distribution pattern PLB shown in FIG. 8(b) is formed by projecting a light source image of the light source 34B formed on a back focus plane of the projection lens 32B by the outgoing light from the light source 34B that is reflected by the reflector 36B, on the above virtual vertical screen as a reverse projection image by the projection lens 32B, and the cutoff lines CL1, CL2 are formed as a reverse projection image of a front end edge 38Ba1 of the upward reflection surface 38Ba of the shade 38B.

An OHS irradiation light distribution pattern PCB is additionally formed also in the second light distribution pattern PLB, and in a space between the OHS irradiation light distribution pattern PCB and the cutoff lines CL1, CL2, a diffusion light-distribution pattern Sb is formed with a weaker brightness than the OHS irradiation light distribution pattern PCA. However, the dark portion D is not formed in the diffusion light-distribution pattern Sb, unlike the diffusion light-distribution pattern Sa shown in FIG. 8(a). This is because the protrusion portion 44Ab is not formed at a region that is on the reflection surface 44Ba of the second additional reflector 44B and that is on the own-vehicle lane side, unlike the case of the second additional reflector 44A.

Accordingly, as shown in FIG. 7, in the OHS irradiation light distribution pattern PC that formed as a synthetic light distribution pattern of the OHS irradiation light distribution pattern PCA shown in FIG. 8(a) and the second light distribution pattern PLB shown in FIG. 8(b), only the dark portion D in the diffusion light-distribution pattern Sa of the diffusion light-distribution patterns Sa, Sb that are concomitantly formed exists. Thereby, the long-distance visibility on the oncoming lane side of a vehicle forward traveling road is secured without causing glare to a driver of the oncoming vehicle 2.

Next, function effects of the embodiment will be described.

The vehicle lighting device 10 according to the embodiment includes the first and second lighting device units 30A, 30B, and both thereof are configured such that parts of the outgoing lights from the light sources 34A, 34B that are reflected by the reflectors 36A, 36B are intercepted by the shades 38A, 38B disposed between the reflectors 36A, 36B and the projection lenses 32A, 32B and the cutoff lines CL1, CL2 of the low-beam light distribution pattern PL are formed, and therefore, the low-beam light distribution pattern PL can be easily formed as a desired light distribution, by the irradiation lights from the first and second lighting device units 30A, 30B.

Furthermore, in both of the first and second lighting device units 30A, 30B, the outgoing lights from the light sources 34A, 34 are sequentially reflected by the first additional reflectors 42A, 42B and the second additional reflectors 44A, 44B, and thereby, as the low-beam light distribution pattern PL, the OHS irradiation light distribution pattern PC can be additionally formed in the space above the cutoff lines CL1, CL2.

On that occasion, the first lighting device unit 30A is configured such that the protrusion portion 44Ab as the light diffusion region is formed at the position that is on the reflection surface 44Aa of the second additional reflector 44A and that is on the own-vehicle lane side of the back focus F of the projection lens 32A. Therefore, it is possible to avoid the space between the cutoff lines CL1, CL2 and the OHS irradiation light distribution pattern PC from becoming brighter than necessary due to the diffusion light-distribution patterns Sa, Sb, and thereby, it is possible to effectively restrain the glare from being caused to the oncoming-vehicle driver.

Further, the protrusion portion 44Ab is formed only in the first lighting device unit 30A. Therefore, it is possible to avoid the space between the cutoff lines CL1, CL2 and the OHS irradiation light distribution pattern PC from becoming excessively dark, and thereby, it is possible to avoid the forward visibility of an own-vehicle driver from decreasing.

In this way, with the embodiment, in the vehicle lighting device 10 including the first and second lighting device units 30A, 30B for forming the low-beam light distribution pattern PL, it is possible to achieve the improvement in the forward visibility of the own-vehicle driver while effectively restraining the glare to the oncoming-vehicle driver.

Particularly, in the embodiment, the light diffusion region is constituted by the protrusion portion 44Ab, and therefore, it is possible to accurately perform a reflection control for avoiding the space between the cutoff lines CL1, CL2 and the OHS irradiation light distribution pattern PC from becoming brighter than necessary.

Further, in the embodiment, as the respective configurations of the first and second lighting device units 30A, 30B, the reflectors 36A, 36B are disposed so as to cover the light sources 34A, 34B from the upward side, and the shades 38A, 38B include the upward reflection surfaces 38Aa, 38Ba that reflect parts of the reflected lights from the reflectors 36A, 36B upward toward the projection lenses 32A, 32B. Therefore, it is possible to efficiently emit the outgoing lights from the light sources 34A, 34B toward the lighting-device forward side, and thereby, it is possible to increase the brightness of the low-beam light distribution pattern PL.

Furthermore, in the embodiment, in both of the first and second lighting device units 30A, 30B, the first additional reflectors 42A, 42B are formed integrally with the reflectors 36A, 36B, and the second additional reflectors 44A, 44B are formed integrally with the shades 38A, 38B. Therefore, it is possible to achieve reduction in the number of components of the vehicle lighting device 10, and it is possible to enhance position relation accuracy between the first additional reflectors 42A, 42B and the reflectors 36A, 36B and position relation accuracy between the second additional reflectors 44A, 44B and the shades 38A, 38B.

Moreover, in the first and second lighting device units 30A, 30B, the reflectors 36A, 36B and the shades 38A, 38B are integrally formed respectively, and therefore, it is possible to achieve further reduction in the number of components of the vehicle lighting device 10.

In the above embodiment, the vehicle lighting device 10 including the two lighting device units: the first and second lighting device units 30A, 30B has been described. It is allowable to adopt a configuration in which a lighting device unit having the same configuration as the first lighting device unit 30A is added and disposed in addition to them or a configuration in which a lighting device unit having the same configuration as the second lighting device unit 30B is added and disposed.

Next, modifications of the above embodiment will be described.

First, a first modification of the above embodiment will be described.

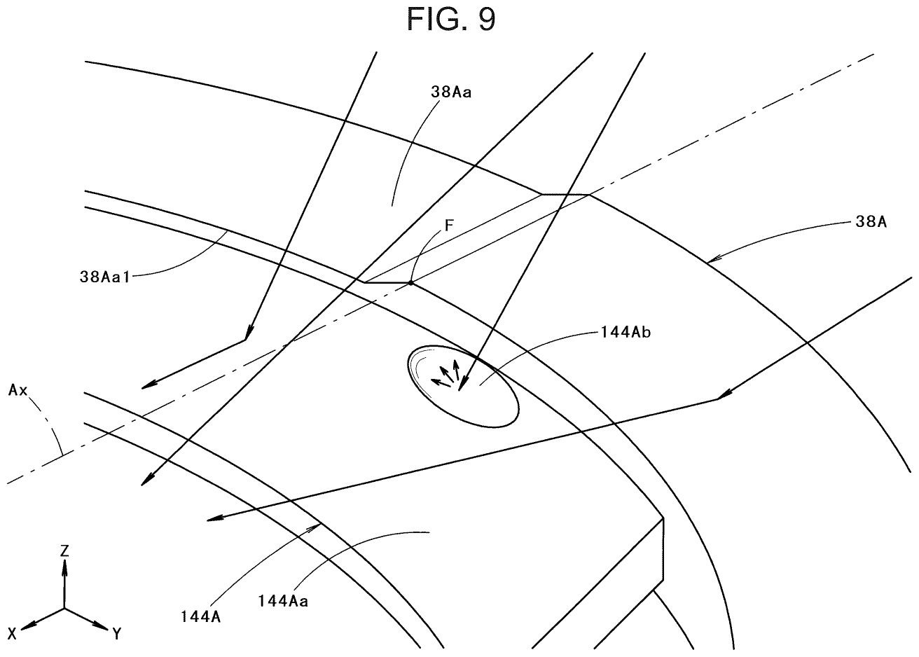

FIG. 9 is a diagram showing a principal part of a vehicle lighting device according to the modification in the same manner as FIG. 6.

As shown in FIG. 9, the basic configuration of the modification is the same as that in the case of the above embodiment, but the configuration of a second additional reflector 144A is partially different from that in the case of the above embodiment.

That is, the second additional reflector 144A in the modification also includes a reflection surface 144Aa similar to the reflection surface 44Aa of the second additional reflector 44A in the above embodiment, but a recessed portion 144Ab as the light diffusion region is formed at the position on the own-vehicle lane side of the optical axis Ax. The recessed portion 144Ab is positioned near an upper end edge of the reflection surface 144Aa, and has a surface shape that is a horizontally-long roughly-elliptical surface shape. Moreover, a part of the outgoing light from the light source 34A that is reflected by the first additional reflector 42A is diffused and reflected by the recessed portion 144Ab.

Even in the case where the configuration in the modification is employed, a part of the reflected light from the reflector 42A is diffused and reflected at the recessed portion 144Ab formed on the reflection surface 144Aa of the second additional reflector 144A, and thereby, it is possible to achieve the improvement in the forward visibility of the own-vehicle driver while effectively restraining the glare to the oncoming-vehicle driver.

Next, a second modification of the above embodiment will be described.

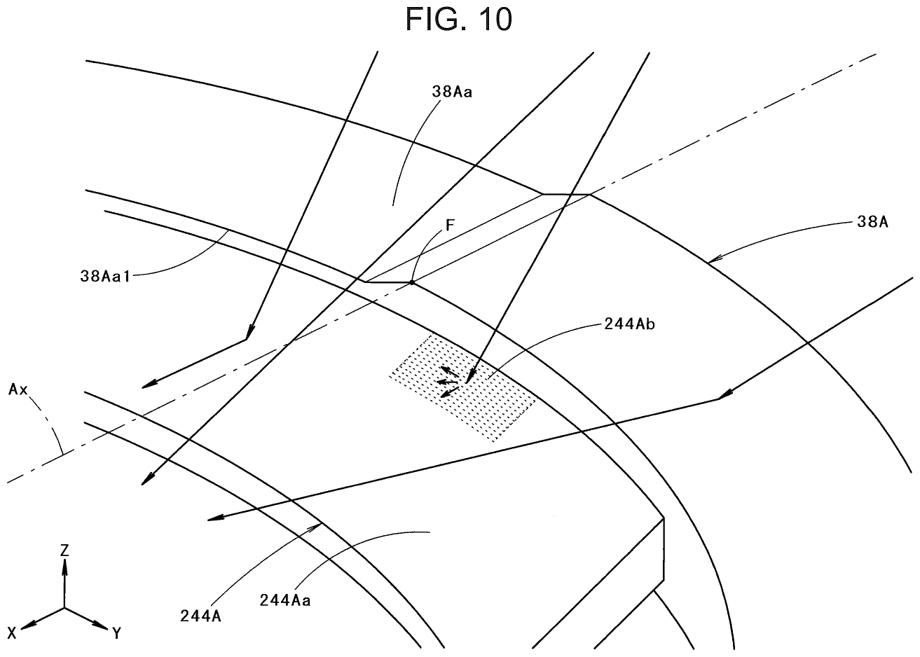

FIG. 10 is a diagram showing a principal part of a vehicle lighting device according to the modification in the same manner as FIG. 6.

As shown in FIG. 10, the basic configuration of the modification is the same as that in the case of the above embodiment, but the configuration of a second additional reflector 244A is partially different from that in the case of the above embodiment.

That is, the second additional reflector 244A in the modification also includes a reflection surface 244Aa similar to the reflection surface 44Aa of the second additional reflector 44A in the above embodiment, but an embossed surface 244Ab as the light diffusion region is formed at the position on the own-vehicle lane side of the optical axis Ax. The embossed surface 244Ab is configured by performing emboss processing to a horizontally-long rectangular region near an upper end edge of the reflection surface 244Aa. Moreover, a part of the outgoing light from the light source 34A that is reflected by the first additional reflector 42A is diffused and reflected by the embossed surface 244Ab.

Even in the case where the configuration in the modification is employed, a part of the reflected light from the reflector 42A is diffused and reflected at the embossed surface 244Ab formed on the reflection surface 244Aa of the second additional reflector 244A, and thereby, it is possible to achieve the improvement in the forward visibility of the own-vehicle driver while effectively restraining the glare to the oncoming-vehicle driver.

Numerical values shown as specifications in the above embodiment and the modifications are just examples, and naturally, different values may be set when appropriate.

Further, the invention in the present application is not limited to the configurations described in the above embodiment and the modifications, and other configurations in which various alterations are performed can be employed.

The present international application claims priority to Japanese Patent Application No. 2022-210877 filed on Dec. 27, 2022, and all contents in Japanese Patent Application No. 2022-210877 are incorporated in the present international application.

The above descriptions about the particular embodiments of the present invention have been presented for the purpose of exemplification. They are not intended to be exhaustive or limit the present invention to only the described forms. A person skilled in the art understands that a large number of modifications and alterations can be made in the context of the above described contents.

### REFERENCE SIGNS LIST

2 oncoming vehicle
10 vehicle lighting device
12 lamp body
14 translucent cover
20 lighting device unit assembly
22 projection lens assembly
30A first lighting device unit
30B second lighting device unit
32A, 32B projection lens
32Aa front surface
32Ab rear surface
34A, 34B light source
34Aa light-emitting surface
36A, 36B reflector
36Aa reflection surface
38A, 38B shade
38Aa, 38Ba upward reflection surface
38Aa1, 38Ba1 front end edge
40 basal plate
42A, 42B first additional reflector
42Aa, 42Ba, 44Aa, 44Ba, 144Aa, 244Aa reflection surface
44A, 44B, 144A, 244A second additional reflector
44Ab protrusion portion (light diffusion region)
50 heatsink
52 body portion
54 radiation fin
60 holder
60a horizontal flange portion
60b frame portion
144Ab recessed portion (light diffusion region)
244Ab embossed surface (light diffusion region)
Ax optical axis
CL1 oncoming-lane-side cutoff line
CL2 own-vehicle-lane-side cutoff line
D dark portion
E elbow point
F back focus
OHS over-head sign
PC, PCA, PCB OHS irradiation light distribution pattern
PL low-beam light distribution pattern
PLA first light distribution pattern
PLB second light distribution pattern
Sa, Sb diffusion light-distribution pattern

1: A vehicle lighting device comprising a plurality of lighting device units for forming a low-beam light distribution pattern, wherein:
each of the lighting device units includes:
a projection lens,
a light source that is disposed on a lighting-device rearward side of a back focus of the projection lens,
a reflector that reflects outgoing light from the light source toward the projection lens, and
a shade that intercepts a part of reflected light from the reflector, in a state of being disposed between the reflector and the projection lens, for forming a cutoff line of the low-beam light distribution pattern;
the each of the lighting device units is configured such that a first additional reflector is disposed at a front end portion of the reflector and a second additional reflector is disposed at a first position on a lighting-device forward side and downward side of the back focus, the first additional reflector reflecting the outgoing light from the light source downward, the second additional reflector reflecting the outgoing light from the light source that is reflected by the first additional reflector, toward the projection lens; and
at least one of the lighting device units among the lighting device units is configured such that a light diffusion region is provided at a second position that is on a reflection surface of the second additional reflector and that is on an own-vehicle lane side of the back focus.

2: The vehicle lighting device according to claim 1, wherein the light diffusion region is constituted by a protrusion portion or a recessed portion.

3: The vehicle lighting device according to claim 1, wherein:
the reflector is disposed so as to cover the light source from an upward side; and
the shade includes an upward reflection surface that reflects the part of the reflected light from the reflector upward toward the projection lens.

4: The vehicle lighting device according to claim 1, wherein:
the first additional reflector is provided integrally with the reflector; and
the second additional reflector is provided integrally with the shade.

5: The vehicle lighting device according to claim 4, wherein the lighting device units are configured such that the reflectors are integrally provided and the shades are integrally provided.
